(19) United States
(12) Patent Application Publication
(10) Pub. No.: US 2023/0036323 A1
(43) Pub. Date: Feb. 2, 2023

(54) INFORMATION PROCESSING APPARATUS, INFORMATION PROCESSING METHOD, AND COMPUTER READABLE RECORDING MEDIUM

(71) Applicant: NEC Corporation, Minato-ku, Tokyo (JP)

(72) Inventor: Kazeto Yamamoto, Tokyo (JP)

(73) Assignee: NEC Corporation, Minato- ku, Tokyo (JP)

(21) Appl. No.: 17/791,392

(22) PCT Filed: Jan. 15, 2020
(86) PCT No.: PCT/JP2020/001125

§ 371 Date: Jul. 7, 2022

(51) Int. Cl. G06N 5/04; G06N 5/00

(52) U.S. Cl. CPC G06N 5/041; G06N 5/003

(57) ABSTRACT

In order to efficiently and rigorously enumerate the combinations of logical formulas that lead to a contradiction with the background knowledge for each hypothesis, the information processing apparatus 1 includes the acquisition unit 2 that acquires the contradiction determination function having a data structure that expresses a combination of logical formulas that contradict the background knowledge, and the potential contradiction enumeration unit 3 enumerates the potential contradiction set, in which literals that contradict the background knowledge in the solution candidate set are combined, by using the contradiction determination function.

### TECHNICAL FIELD

The present invention relates to an inference processing method in a system based on abduction, and more particularly to an information processing apparatus, an information processing method and a computer-readable recording medium for efficiently verifying consistency of an output hypothesis.

### BACKGROUND ART

Abduction (Abductive reasoning) is an inference method that outputs, based on a function (Evaluation function) that receives a query formula and background knowledge and expresses quality of each candidate in real values, best hypothesis (Solution hypothesis) from logical formulas (Hypotheses) that are consistent with the background knowledge and deductively derive the query formula.

The existing methods for implementing abduction on a computer can be roughly divided into two types. In one type, as described in Non-Patent Document 1, the best hypothesis candidates (Candidate hypotheses) are enumerated from the query formula and background knowledge, and the problem of searching for the best hypothesis from the enumerated candidates is equivalently transformed into a constrained combinatorial optimization problem such as an integer linear programming problem, and then the best hypothesis is obtained using an external solver.

In the other type, as described in Non-Patent Document 2, the structure of the background knowledge is transformed so that the inference equivalent to the abduction is realized on the deductive inference model such as Answer Set Programming, and the query formula and the transformed background knowledge are applied to the software of the deductive inference model, and then the best hypothesis is obtained.

### LIST OF RELATED ART DOCUMENTS

### Non-Patent Document

Non-Patent Document 1: Naoya Inoue and Kentaro Inui. ILP-based Reasoning for Weighted Abduction. In Proceedings of AAAI Workshop on Plan, Activity and Intent Recognition, pp. 25-32, August 2011.

Non-Patent Document 2: Peter Schuller. Modeling Variations of First-Order Horn

Abduction in Answer Set Programming. In Fundamenta Informaticae, vol. 149, no. 1-2, pp. 159-207, 2016.

### SUMMARY OF INVENTION

### Problems to be Solved by the Invention

Each candidate hypothesis must theoretically be consistent with background knowledge. However, in the inference on the computer, their consistency is not rigorously verified. That is, in any of the existing implementation methods, the candidate hypothesis is constructed by tracing the background knowledge in the reverse direction starting from the query formula. Therefore, even in cases where a contradiction is derived from the hypothesis, that hypothesis is treated as a candidate hypothesis. As a result, the conventional implementation does not strictly guarantee the consistency of the hypothesis, and there is a possibility that a hypothesis that is inconsistent with the background knowledge may be derived.

An example of object of the present invention is to provide an information processing apparatus, an information processing method and a computer-readable recording medium, which can efficiently enumerate potential inconsistencies existing between candidate hypotheses and background knowledge.

### Means for Solving the Problems

In order to achieve the above object, an information processing apparatus in one aspect of the present invention includes:

an acquisition unit that acquires a contradiction determination function having a data structure that expresses a combination of logical formulas that contradict background knowledge, and

a potential contradiction enumeration unit that enumerates potential contradiction set, in which literals that contradict the background knowledge in a solution candidate set are combined, by using the contradiction determination function.

Further, in order to achieve the above object, an information processing method in one aspect of the present invention includes:

acquiring a contradiction determination function having a data structure that expresses a combination of logical formulas that contradict background knowledge, and

enumerating potential contradiction set, in which literals that contradict the background knowledge in a solution candidate set are combined, by using the contradiction determination function.

Further, in order to achieve the above object, a computer-readable recording medium in one aspect of the present invention includes a program recorded thereon, the program including instructions that cause a computer to execute:

acquiring a contradiction determination function having a data structure that expresses a combination of logical formulas that contradict background knowledge, and

enumerating potential contradiction set, in which literals that contradict the background knowledge in a solution candidate set are combined, by using the contradiction determination function.

### Advantageous Effects of the Invention

According to the present invention, it is possible to efficiently and rigorously enumerate the combinations of logical formulas that lead to a contradiction with the background knowledge for each hypothesis.

### BRIEF DESCRIPTION OF THE DRAWINGS

FIG. 1 is a block diagram showing a schematic configuration of the information processing apparatus.

FIG. 2 is a block diagram showing a specific configuration of the information processing apparatus.

FIG. 3 is a block diagram showing a relationship between the units of the information processing apparatus.

FIG. 4 shows an example of background knowledge and query formula.

FIG. 5 is a diagram for explaining a candidate hypothesis output from background knowledge and query formula.

FIG. 6 is a diagram showing an example of a contradiction determination function.

FIG. 7 is a flow diagram showing an operation of an information processing apparatus.

FIG. 8 is a block diagram showing an example of a computer that realizes an information processing apparatus.

### EXAMPLE EMBODIMENTS

### Description of Configuration

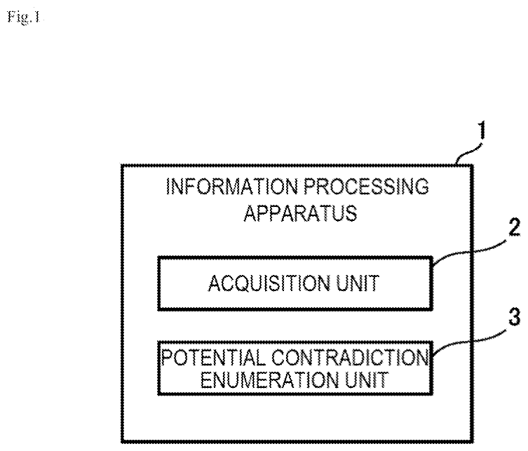

FIG. 1 is a block diagram showing a schematic configuration of the information processing apparatus 1.

The information processing apparatus 1 includes an acquisition unit 2 and a potential contradiction enumeration unit 3.

The acquisition unit 2 acquires a contradiction determination function having a data structure expressing a combination of logical formulas that contradict background knowledge. The data structure is, for example, a binary decision diagram (BDD). Further, the contradiction determination function is a logical function that returns a boolean value indicating whether or not it contradicts the background knowledge for an arbitrary logical formula, and is data expressed based on the data structure.

The potential contradiction enumeration unit 3 enumerates potential contradiction set, in which literals that contradict the background knowledge in a solution candidate set are combined, by using the contradiction determination function acquired by the acquisition unit 2. The solution candidate set includes solution hypothesis candidates enumerated from a query formula and background knowledge.

The information processing apparatus 1 can efficiently and rigorously enumerate combinations of logical formulas that lead to contradictions with the background knowledge for each hypothesis. The reason for this is that by constructing data that enumerates patterns that lead to contradictions in advance, the actual processing during inference can be made more efficient.

In addition, since combinations of logical formulas that lead to contradictions can be efficiently enumerated for each candidate hypothesis, the solution hypothesis can be searched from only candidate hypotheses that do not lead to contradiction by searching for the optimal solution with constraints so that those logical formulas do not hold true. Thus, the information processing apparatus 1 can guarantee consistency for the solution hypothesis.

Furthermore, the combination of logical formulas that leads to contradiction can be expressed efficiently in terms of data size, by expressing the combination as a logical function for determining inconsistency and by using a data structure similar to the binary decision diagram, which is a data structure that can efficiently express the logical function. Therefore, the information processing apparatus 1 can hold the data enumerating the patterns leading to the contradiction in a relatively efficient memory amount.

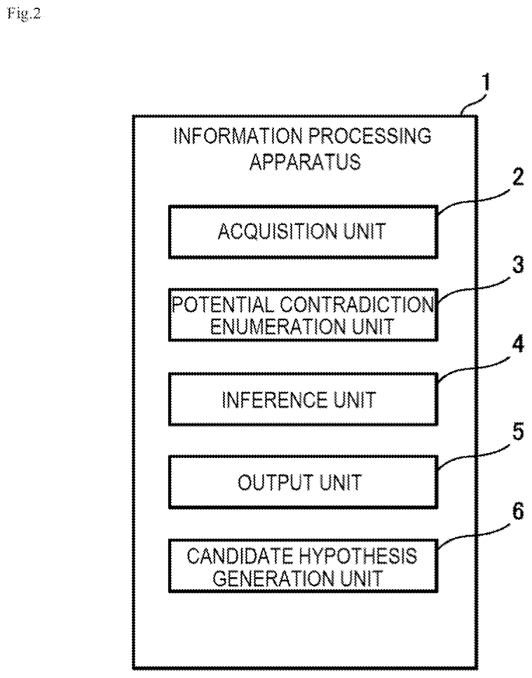

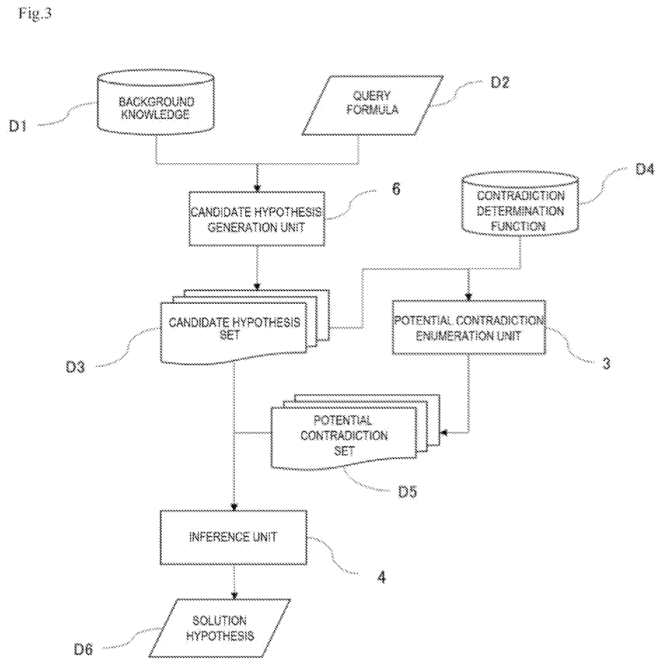

FIG. 2 is a block diagram showing a specific configuration of the information processing apparatus 1. FIG. 3 is a block diagram showing a relationship between the units of the information processing apparatus 1.

The information processing apparatus 1 includes an inference unit 4, an output unit 5, and a candidate hypothesis generation unit 6 in addition to the acquisition unit 2 and the potential contradiction enumeration unit 3 described above.

The candidate hypothesis generation unit 6 generates candidate hypothesis set D3 by using the background knowledge D1 and query formula D2 as inputs. The background knowledge D1 is a set of inference rules. The inference rules are generally represented by Horn clauses in first-order predicate logic. The query formula D2 is a conjunction of first-order predicate logic literals. The first-order predicate logic literal is an atomic logic formula in first-order predicate logic or the negation of that formula. The candidate hypothesis set D3 is a set of candidate hypotheses. Each candidate hypothesis is expressed as a conjunction of first-order predicate logic literals.

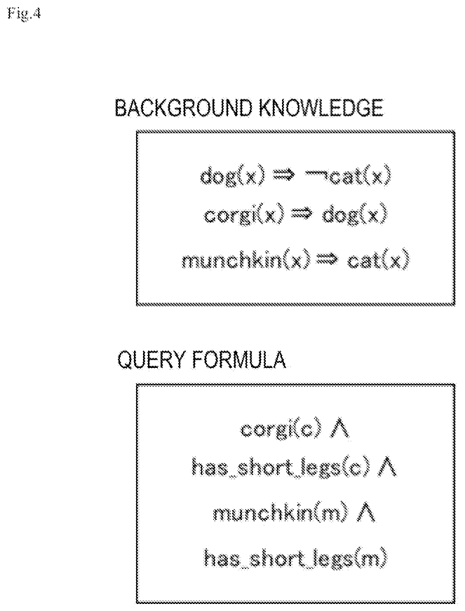

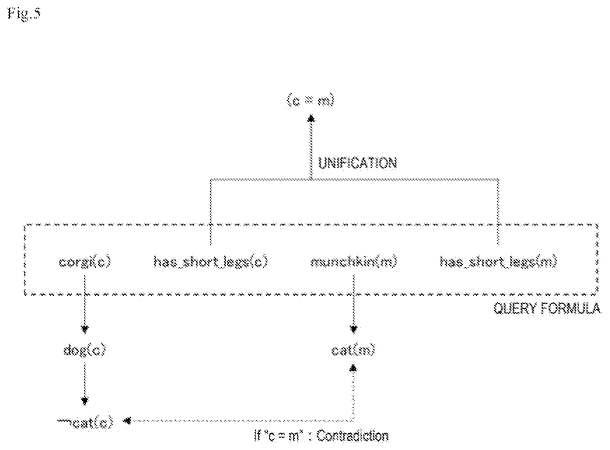

FIG. 4 shows an example of the background knowledge D1 and query formula D2. FIG. 5 is a diagram for explaining a candidate hypothesis output from the background knowledge D1 and query formula D2.

In the example of FIG. 4, there is a literal pair having the same predicate “has_short_legs”. The candidate hypothesis generation unit 6 generates a candidate hypothesis including an equivalence relationship “c=m” as shown in FIG. 5 by applying a unification operation to the same predicate.

The acquisition unit 2 acquires a contradiction determination function D4 (see FIG. 3) having a data structure which is the binary decision diagram.

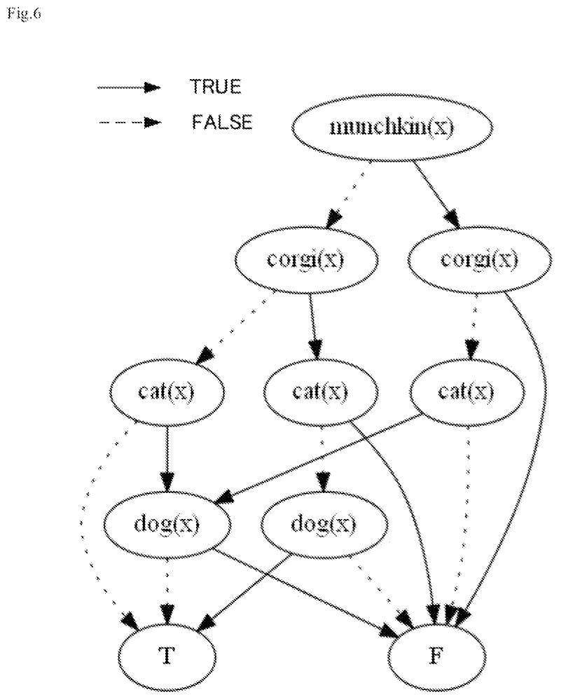

FIG. 6 is a diagram showing an example of the contradiction determination function D4. As shown in FIG. 6, the contradiction determination function D4 is the binary decision diagram showing a combination of logical formulas that contradicts the background knowledge Dl. In FIG. 6, the logical formula corresponding to the boolean value assignment such that the output value is F (False) contradicts the background knowledge D1.

The potential contradiction enumeration unit 3 enumerates (outputs) potential contradiction set D5 by using the contradiction determination function D4 acquired by the acquisition unit 2 and the candidate hypothesis set D3 output by the candidate hypothesis generation unit 6 as inputs. The potential contradiction enumeration unit 3 determines whether all combinations of literals in the candidate hypothesis set contradict the background knowledge D1 using a contradiction determination function, and enumerates the combinations of literals that contradict the background knowledge D1. In the example in FIG. 5, it is searched for combinations that lead to a contradiction from the predicate “corgi, munchkin” only. In this case, from the BDD shown in FIG. 6, it can be seen that if both corgi(x) and munchkin(x) are true, then a contradiction is derived. Next, the potential contradiction enumeration unit 3 enumerates combinations of literals that lead to a contradiction, by searching for combinations of literals that satisfy the above combination of logical formulas from candidate hypotheses. In the example in FIG. 5, {corgi(c) A munchkin(m) A (m=c)} is obtained as the combination that leads to a contradiction.

In another method, BDD variables that have the potential to have a boolean value determined by the candidate hypothesis are enumerated, and a boolean assignment that leads to contradiction within the range of BDD variable is searched for. Then, if the assignment exists, a combination of literals corresponding to the assignment is searched from the candidate hypotheses.

The inference unit 4 executes abduction by searching the solution hypothesis D6 from the candidate hypothesis set D3 and the potential contradiction set D5 enumerated by the potential contradiction enumeration unit 3. The solution hypothesis D6 is a candidate hypothesis considered to be the best based on the evaluation function among the candidate hypotheses included in the candidate hypothesis set D3. In this embodiment, the solution hypothesis D6 is guaranteed to be strictly consistent with the background knowledge D1. Specifically, the inference unit 4 expresses and outputs a calculation for selecting the solution hypothesis D6 from the candidate hypothesis set D3 as a constrained combinatorial optimization problem such as an integer linear programming problem. At this time, the potential contradiction set D5 is expressed as a constraint in the optimization problem as a combination of logical formulas that should not hold true at the same time. In this case, an existing transformation method can be used to derive the solution hypothesis at high speed by expressing the procedure for selecting the best hypothesis as an equivalent integer linear programming problem and solving it using an external integer linear programming solver, as shown in the Non-Patent Document 1. In this case, the condition that “the combination included in the potential contradiction set is not satisfied” is expressed as a constraint in the integer linear programming problem. Other methods can also be used.

The output unit 5 outputs a literal that is consistent with the background knowledge D1 as a result of abduction.

In addition, in FIGS. 4 and 5, in theory, the literals dog(c) and cat(m) are deductively derived from the background knowledge D1 and the query formula D2. However, these literals cannot be considered in the conventional method. Therefore, since it cannot be detected that the equivalence relationship “c=m” potentially causes a contradiction, the conventional method outputs a candidate hypothesis including the equivalence relationship “c=m” as the best hypothesis. This contradicts the theoretical definition that the hypothesis must be consistent.

On the other hand, it is not easy to realize such hypothetical consistency in a straightforward manner. For example, an implementation method based on a constrained combinatorial optimization problem as described in the Non-Patent Document 1 may be used to implement strict consistency verification in a straightforward manner. In this case, for each of the candidate hypotheses, it is necessary to enumerate all logical formulas that can be deductively derived from the candidate hypothesis, search for combinations among them that lead to contradiction, and enumerate all combinations of literals in the candidate hypothesis that leads to contradiction. Such a process during inference would cause a significant increase in computation time and is not realistic. In addition, in the implementation method as described in the Non-Patent Document 2, which imitates abduction on another deductive reasoning model, it is in principle impossible to simultaneously consider deductive reasoning since abduction is expressed by transforming the structure of background knowledge.

### [Apparatus Operations]

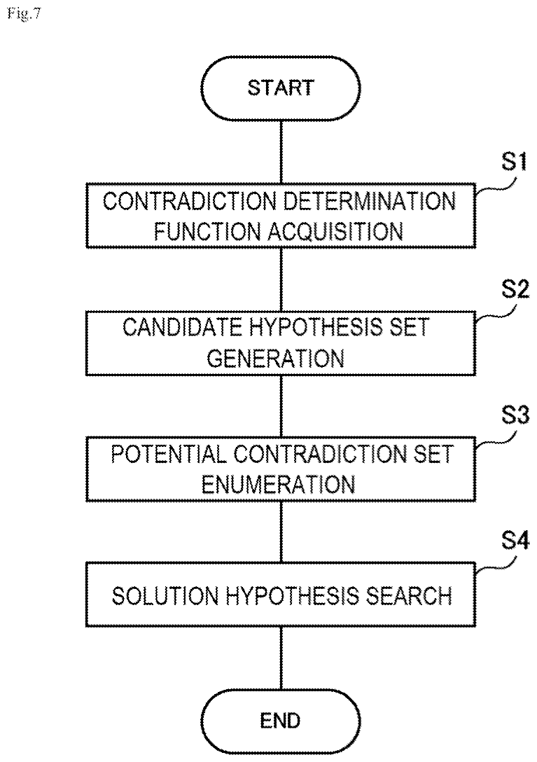

Next, the operation of the information processing apparatus 1 will be described with reference to FIG. 7. FIG. 7 is a flow diagram showing the operation of the information processing apparatus 1. In the example embodiment, the information processing method is implemented by operating the information processing apparatus 1. Therefore, the description of the information processing method in the example embodiment will be replaced with the following description of the operation of the information processing apparatus 1.

The acquisition unit 2 acquires the contradiction determination function D4 having the data structure expressing the combination of logical formulas that contradict the background knowledge D1 (S1). Next, the candidate hypothesis generation unit 6 generates the candidate hypothesis set D3 by using the background knowledge D1 and query formula D2 as inputs (S2). It is noted that the order of S1 and S2 is not limited to the above order.

Next, the potential contradiction enumeration unit 3 enumerates the potential contradiction set D5 by using the contradiction determination function D4 and the candidate hypothesis set D3 as inputs (S3). Then, the inference unit 4 executes abduction by searching the solution hypothesis D6 from the candidate hypothesis set D3 and the potential contradiction set D5 (S4).

### [Program]

It is sufficient for the program according to the example embodiment to be a program that causes a computer to execute steps S1 to S4 shown in FIG. 7. The information processing apparatus 1 and the information processing method according to the example embodiment can be realized by installing this program in the computer and executing this program. In this case, a processor of the computer functions as the acquisition unit 2, the potential contradiction enumeration unit 3, the inference unit 4, the output unit 5, and candidate hypothesis generation unit 6, and performs processing.

### [Physical Configuration]

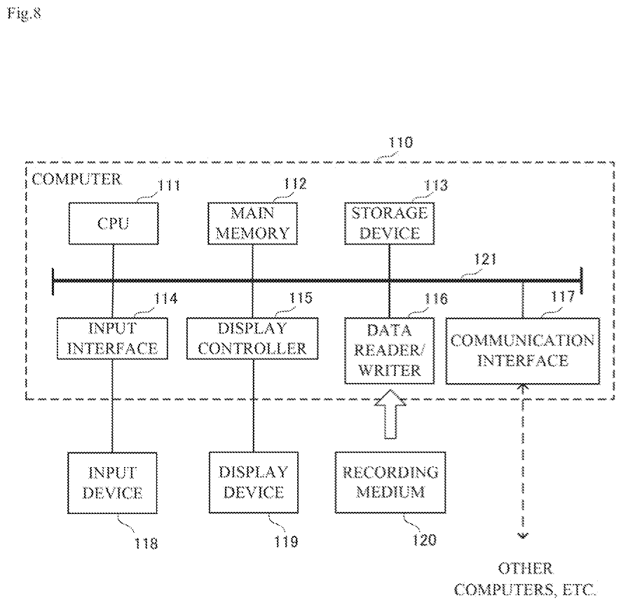

Here, a computer that realizes the information processing apparatus by executing the programs in the example embodiment will be described with reference to FIG. 8. FIG. 8 is a block diagram illustrating one example of a computer realizing the information processing apparatus.

As illustrated in FIG. 8, a computer 110 includes a CPU (Central Processing Unit) 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a GPU (Graphics Processing Unit) or a FPGA (Field-Programmable Gate Array) in addition to the CPU 111 or in place of the CPU 111.

The CPU 111 loads the program (codes) in the example embodiment, which are stored in the storage device 113, onto the main memory 112, and performs various computations by executing these codes in a predetermined order. The main memory 112 is typically a volatile storage device such as a DRAM (Dynamic Random Access Memory). Furthermore, the program in the example embodiment is provided in a state such that the program is stored in a computer readable recording medium 120. Note that the program in the example embodiment may also be program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119. The data reader/writer 116 mediates data transmission between the CPU 111 and the recording medium 120, and executes the reading out of the program from the recording medium 120 and the writing of results of processing in the computer 110 to the recording medium 120. The communication interface 117 mediates data transmission between the CPU 111 and other computers.

Furthermore, specific examples of the recording medium 120 include a general-purpose semiconductor storage device such as a CF (Compact Flash; registered trademark) card or a SD (Secure Digital) card, a magnetic recording medium such as a flexible disk, and an optical recording medium such as a CD-ROM (Compact Disk Read Only Memory).

While a part of or the entirety of the above-described example embodiment can be expressed by (Supplementary note 1) to (Supplementary note 15) described in the following, the invention is not limited to the following description.

(Supplementary Note 1)

An information processing apparatus including:

an acquisition unit that acquires a contradiction determination function having a data structure that expresses a combination of logical formulas that contradict background knowledge, and

a potential contradiction enumeration unit that enumerates potential contradiction set, in which literals that contradict the background knowledge in a solution candidate set are combined, by using the contradiction determination function.

(Supplementary Note 2)

The information processing apparatus according to Supplementary note 1, wherein the data structure is a binary decision diagram.

(Supplementary Note 3)

The information processing apparatus according to Supplementary note 1 or 2, wherein the potential contradiction enumeration unit determines whether all combinations of literals in the solution candidate set contradict the background knowledge using the contradiction determination function, and enumerates combinations of literals that contradict the background knowledge.

(Supplementary Note 4)

The information processing apparatus according to Supplementary note 2, wherein the potential contradiction enumeration unit enumerates BDD variables that have potential to have a boolean value determined by the solution candidate set, searches for a boolean assignment that leads to contradiction within a range of the variables, and searches for a combination of literals corresponding to the assignment from the solution candidate set when the assignment exists.

(Supplementary Note 5)

The information processing apparatus according to any one of Supplementary notes 1 to 4, further including:

an inference unit that executes abduction based on the solution candidate set and the potential contradiction set, and

an output unit that outputs a literal that is consistent with the background knowledge as a result of the abduction.

(Supplementary Note 6)

An information processing method including:

(A) a step of acquiring a contradiction determination function having a data structure that expresses a combination of logical formulas that contradict background knowledge, and

(B) a step of enumerating potential contradiction set, in which literals that contradict the background knowledge in a solution candidate set are combined, by using the contradiction determination function.

(Supplementary Note 7)

The information processing method according to Supplementary note 6, wherein

the data structure is a binary decision diagram.

(Supplementary Note 8)

The information processing method according to Supplementary note 6 or 7, wherein in the (B) step,

determining whether all combinations of literals in the solution candidate set contradict the background knowledge using the contradiction determination function, and enumerating combinations of literals that contradict the background knowledge.

(Supplementary Note 9)

The information processing method according to Supplementary note 7, wherein in the (B) step,

enumerating BDD variables that have potential to have a boolean value determined by the solution candidate set, searching for a boolean assignment that leads to contradiction within a range of the variables, and searching for a combination of literals corresponding to the assignment from the solution candidate set when the assignment exists.

(Supplementary note 10)

The information processing method according to any one of Supplementary notes 6 to 9, further including:

(C) a step of executing abduction based on the solution candidate set and the potential contradiction set, and

(D) a step of outputting a literal that is consistent with the background knowledge as a result of the abduction.

(Supplementary Note 11)

A computer-readable recording medium that includes a program recorded thereon, the program including instructions that cause a computer to execute:

(A) a step of acquiring a contradiction determination function having a data structure that expresses a combination of logical formulas that contradict background knowledge, and

(B) a step of enumerating potential contradiction set, in which literals that contradict the background knowledge in a solution candidate set are combined, by using the contradiction determination function.

(Supplementary Note 12)

The computer-readable recording medium according to Supplementary note 11, wherein

the data structure is a binary decision diagram.

(Supplementary Note 13)

The computer-readable recording medium according to Supplementary note 11 or 12, wherein

in the (B) step,

determining whether all combinations of literals in the solution candidate set contradict the background knowledge using the contradiction determination function, and enumerating combinations of literals that contradict the background knowledge.

(Supplementary Note 14)

The computer-readable recording medium according to Supplementary note 12, wherein in the (B) step,

enumerating BDD variables that have potential to have a boolean value determined by the solution candidate set, searching for a boolean assignment that leads to contradiction within a range of the variables, and searching for a combination of literals corresponding to the assignment from the solution candidate set when the assignment exists.

(Supplementary Note 15)

The computer-readable recording medium according to any one of Supplementary notes 11 to 14, wherein

the program further includes instructions that cause the computer to execute:

(C) a step of executing abduction based on the solution candidate set and the potential contradiction set, and

(D) a step of outputting a literal that is consistent with the background knowledge as a result of the abduction.

### REFERENCE SIGNS LIST

1 Information processing apparatus

2 Acquisition unit

3 Potential contradiction enumeration unit

4 Inference unit

5 Output unit

6 Candidate hypothesis generation unit

D1 Background knowledge

D2 Query formula

D3 Candidate hypothesis set

D4 Contradiction determination function

D5 Potential contradiction set

D6 Solution hypothesis

What is claimed is:

1. An information processing apparatus comprising:
an acquisition unit that acquires a contradiction determination function having a data structure that expresses a combination of logical formulas that contradict background knowledge, and
a potential contradiction enumeration unit that enumerates potential contradiction set, in which literals that contradict the background knowledge in a solution candidate set are combined, by using the contradiction determination function.

2. The information processing apparatus according to claim 1, wherein
the data structure is a binary decision diagram.

3. The information processing apparatus according to claim 1, wherein
the potential contradiction enumeration unit determines whether all combinations of literals in the solution candidate set contradict the background knowledge using the contradiction determination function, and enumerates combinations of literals that contradict the background knowledge.

4. The information processing apparatus according to claim 2, wherein
the potential contradiction enumeration unit enumerates BDD variables that have potential to have a boolean value determined by the solution candidate set, searches for a boolean assignment that leads to contradiction within a range of the variables, and searches for a combination of literals corresponding to the assignment from the solution candidate set when the assignment exists.

5. The information processing apparatus according to claim 1, further comprising:
an inference unit that executes abduction based on the solution candidate set and the potential contradiction set, and
an output unit that outputs a literal that is consistent with the background knowledge as a result of the abduction.

6. An information processing method comprising:
acquiring a contradiction determination function having a data structure that expresses a combination of logical formulas that contradict background knowledge, and
enumerating potential contradiction set, in which literals that contradict the background knowledge in a solution candidate set are combined, by using the contradiction determination function.

7. A non-transitory computer-readable recording medium that includes a program recorded thereon, the program including instructions that cause a computer to execute:
acquiring a contradiction determination function having a data structure that expresses a combination of logical formulas that contradict background knowledge, and
enumerating potential contradiction set, in which literals that contradict the background knowledge in a solution candidate set are combined, by using the contradiction determination function.

8. The information processing method according to claim 6, wherein
the data structure is a binary decision diagram.

9. The information processing method according to claim 6, wherein
when enumerating the potential contradiction set,
determining whether all combinations of literals in the solution candidate set contradict the background knowledge using the contradiction determination function, and enumerating combinations of literals that contradict the background knowledge.

10. The information processing method according to claim 8, wherein
when enumerating the potential contradiction set,
enumerating BDD variables that have potential to have a boolean value determined by the solution candidate set, searching for a boolean assignment that leads to contradiction within a range of the variables, and searching for a combination of literals corresponding to the assignment from the solution candidate set when the assignment exists.

11. The information processing method according to claim 6, further comprising:
executing abduction based on the solution candidate set and the potential contradiction set, and
outputting a literal that is consistent with the background knowledge as a result of the abduction.

12. The non-transitory computer-readable recording medium according to claim 7, wherein
the data structure is a binary decision diagram.

13. The non-transitory computer-readable recording medium according to claim 7, wherein
when enumerating the potential contradiction set,
determining whether all combinations of literals in the solution candidate set contradict the background knowledge using the contradiction determination function, and enumerating combinations of literals that contradict the background knowledge.

14. The non-transitory computer-readable recording medium according to claim 12, wherein
when enumerating the potential contradiction set,
enumerating BDD variables that have potential to have a boolean value determined by the solution candidate set, searching for a boolean assignment that leads to contradiction within a range of the variables, and searching for a combination of literals corresponding to the assignment from the solution candidate set when the assignment exists.

15. The non-transitory computer-readable recording medium according to claim 7, wherein
the program further includes instructions that cause the computer to execute:
executing abduction based on the solution candidate set and the potential contradiction set, and
outputting a literal that is consistent with the background knowledge as a result of the abduction.
